(19) United States
(12) Patent Application Publication
(10) Pub. No.: US 2023/0064930 A1
(43) Pub. Date: Mar. 2, 2023

(54) WALKING SUPPORT SYSTEM

(71) Applicant: TOYOTA JIDOSHA KABUSHIKI KAISHA, Aichi-Ken (JP)

(72) Inventors: Hiroaki KAWAMURA, Nagoya-shi (JP); Kohei SHINTANI, Nisshin-shi (JP)

(21) Appl. No.: 17/847,172

(22) Filed: Jun. 23, 2022

(30) Foreign Application Priority Data
Aug. 17, 2021 (JP) 2021-132572

(51) Int. Cl. G06V 20/50; G06T 7/50; G06T 7/12; G06T 7/11; G06V 10/75; G08G 1/005; A61H 3/06

(52) U.S. Cl. CPC G06V 20/50; G06T 7/50; G06T 7/12; G06T 7/11; G06V 10/759; G08G 1/005; A61H 3/068; G06T 2207/20081; G06T 2207/20021; A61H 2003/063; A61H 2201/5092

(57) ABSTRACT

When there is an area that cannot be confirmed as a white line based on an image acquired by a camera, it is determined that the area that cannot be confirmed as the white line is an area that can be regarded as the white line, on condition that the area that cannot be confirmed as the white line is located in an area between a first straight line connecting edges of one ends of the area that can be confirmed as the white line in a longitudinal direction of the white line and extension lines of the first straight line, and a second straight line connecting edges of the other ends and extension lines of the second straight line. For the area that can be regarded as the white line, a shape of the area in the image is set to a shape as a white line.

### CROSS-REFERENCE TO RELATED APPLICATION

This application claims priority to Japanese Patent Application No. 2021-132572 filed on Aug. 17, 2021, incorporated herein by reference in its entirety.

### BACKGROUND

### 1. Technical Field

The present disclosure relates to a walking support system. In particular, the present disclosure relates to an improvement for improving the recognition accuracy of a white line (band) on a crosswalk when supporting the walking of a pedestrian such as a visually impaired person.

### 2. Description of Related Art

A system disclosed in Re-publication of PCT International Publication No. 2018-025531 (WO 2018-025531) is known as a system (walking support system) that performs various notifications (for example, a stop notification before a crosswalk) to a pedestrian such as a visually impaired person so that the pedestrian can cross the crosswalk safely. WO 2018-025531 discloses a technique including a direction determination unit that determines the direction in which a person who acts without using vision (a visually impaired person) walks and a guide information generation unit that generates guide information for guiding the visually impaired person to walk in the determined direction. In the technique, the walking direction of the visually impaired person is determined by matching an image from a camera carried by the visually impaired person and a reference image stored in advance to guide the visually impaired person with the walking direction by voice or the like.

In a situation where the pedestrian (such as the visually impaired person) actually approaches a crosswalk, the position where the pedestrian should stop when a traffic light (for example, a pedestrian traffic light) is a red light is a position before the crosswalk. Therefore, when a stop notification is performed to the pedestrian before the crosswalk, it is necessary to accurately recognize the position of a white line of the crosswalk (particularly the white line closest to the pedestrian) based on information (image information) from an image acquisition unit such as a camera. In the following description, the white line of the crosswalk may be called a band.

The recognition of the crosswalk is performed by detecting a white part in the acquired image. It is difficult to accurately recognize the white line when the white line of the crosswalk is blurred (a state where a part of the paint forming the white line is peeled off) or covered (a state where a part of the white line is covered with an object of another color, for example, covered with fallen leaves or mud). FIG. 26 shows an example of an image captured by an image acquisition unit (an image acquisition unit carried by a pedestrian) such as a camera in a situation where a white line wl1 closest to the pedestrian on the crosswalk cw is blurred. The long-dashed double-short-dashed line in this figure indicates the range in which the original white line wl1 was drawn. When the white line wl1 of the crosswalk cw is blurred in this way, it is difficult to determine from the information of the captured image whether the detected white part is the white line (a part of the white line wl1), and when the white part is the white line wl1, it is difficult to accurately recognize the shape of the white line wl1 (the shape in a state in which blurring has not occurred). Therefore, there is a possibility that walking support cannot be accurately provided to pedestrians.

The situation where the white line of the crosswalk cannot be recognized accurately includes not only when the white line is blurred or covered as described above, but also the case where the dimension in the longitudinal direction of each white line (the dimension in the direction orthogonal to the crossing direction) is different from each other. FIG. 27 shows an example of an image, captured by an image acquisition unit (an image acquisition unit carried by a pedestrian) such as a camera, of a crosswalk cw in which the length dimension of the white line wl1 closest to a pedestrian on the crosswalk cw (the length dimension in a state where no blurring or the like has occurred) is shorter than the length dimensions of other white lines. Even in such a case, it is difficult to accurately recognize the white line wl1 having a short length dimension from the information of the captured image. Therefore, there is a possibility that walking support cannot be accurately provided to pedestrians.

Japanese Unexamined Patent Application Publication No. 2020-61020 (JP 2020-61020 A) is known as a technique for recognizing a white line on a crosswalk. JP 2020-61020 A discloses a crosswalk marking estimation device mounted on a vehicle. Based on a plan view road surface image of a road around the vehicle and a template image for detecting the end portion of a hand (white line of the crosswalk), the crosswalk marking estimation device acquires the end portion candidates of the hand on the plan view road surface image, and based on the distribution of the acquired end portion candidates on the plan view road surface image, selects the selected end portion candidates, which are the end portion candidates corresponding to the edge of the crosswalk marking, from the situation of the group of the end portion candidates in the road extending direction, to estimate the position of the edge of the crosswalk marking with respect to the vehicle based on the selected end portion candidates.

### SUMMARY

However, the crosswalk marking estimation device disclosed in JP 2020-61020 A is mounted on a vehicle. That is, the crosswalk marking estimation device is based on the technical idea of improving the recognition accuracy of the band extending in the direction along the traveling direction (traveling direction of the vehicle). On the other hand, in the walking support system for allowing pedestrians to safely cross the crosswalk, it is required to improve the recognition accuracy for a band extending in the direction intersecting with the traveling direction (direction of crossing the crosswalk). Therefore, even if the vehicle-specific technique (technique for accurately recognizing the hand of the crosswalk ahead of the vehicle) disclosed in JP 2020-61020 A is applied to the walking support system as it is, there is no guarantee that the band of the crosswalk can be accurately recognized.

In particular, in the technique disclosed in JP 2020-61020 A, when the band of the crosswalk is unclear, the end portion candidates are calculated by template matching to estimate the edge with respect to the vehicle. For this reason, when the end portion of the band is unclear, template matching is not performed, so the crosswalk cannot be recognized. Thus, there is room for improvement in the recognition accuracy of the crosswalk.

The present disclosure has been made in view of this point, and an object of the present disclosure is to provide a walking support system capable of obtaining high recognition accuracy of a band of a crosswalk.

A solution of the present disclosure for achieving the above object is premised on a walking support system that supports walking for a pedestrian in a situation where the pedestrian approaches a crosswalk, The walking support system includes an image acquisition unit, a crosswalk detection unit, and a band shape setting unit. The image acquisition unit acquires an image in front of the pedestrian who is walking. The crosswalk detection unit is able to detect the crosswalk based on the image acquired by the image acquisition unit. The band shape setting unit is able to extract an area that is able to be confirmed as a band constituting the crosswalk and an area that is not able to be confirmed as the band based on the image acquired by the image acquisition unit, determines whether the area that is not able to be confirmed as the band is an area that is able to he regarded as the band based on a relative position of the area that is not able to be confirmed as the band with respect to the area that is able to be confirmed as the band when there is the area that is not able to be confirmed as the band, and sets a shape of the area that is not able to be confirmed as the band in the image to a shape as the band when determining that the area that is not able to be confirmed as the band is the area that is able to be regarded as the band.

Due to this specific matter, in a situation where there is no area that cannot be confirmed as a band based on the image acquired by the image acquisition unit and all the bands in the crosswalk can be recognized, an operation of supporting walking of the pedestrian is performed according to the position of these bands (for example, when the pedestrian reaches the position of the crosswalk before the hand closer to the pedestrian, a stop notification for urging the pedestrian to stop is performed). However, when there is an area that cannot be confirmed as a band, it is determined whether the area that cannot be confirmed as a band is an area that can be regarded as a band based on the relative position of the area that cannot be confirmed as a band with respect to the area that can be confirmed as a band. When it is determined that the area is an area that can he regarded as a band, the shape of the area in the image is set to the shape as a band. As a result, even when, for example, a part of the band is unclear and the band cannot be confirmed as a band only by the acquired image, high recognition accuracy of the band can be obtained. Therefore, it is possible to appropriately support walking of the pedestrian according to the position of the band.

The crosswalk detection unit acquires information on a band shape set by the band shape setting unit when there is the area that is not able to be confirmed as the band, and recognizes an edge position of the crosswalk closer to the pedestrian based on the information. The walking support system includes a notification unit that performs a stop notification for urging the pedestrian to stop when the pedestrian reaches a position before the recognized edge position closer to the pedestrian.

As a result, even when the band closest to the pedestrian is unclear (even when the band is in an area that cannot be confirmed as a band), high recognition accuracy of the band (recognition accuracy of the band closest to the pedestrian) can be obtained based on information on the band shape set by the band shape setting unit, so that it is possible to perform a stop notification for urging the pedestrian to stop when the pedestrian reaches a position before the crosswalk and to perform appropriate walking support.

The band shape setting unit is configured to compare an image obtained by performing a binarization process on the image acquired by the image acquisition unit and an image obtained by performing recognition of a band by deep learning on the image acquired by the image acquisition unit, and define an area recognized as a band confirmed area in bath images as the area that is able to be confirmed as the band and define an area recognized as the band confirmed area in only one image of the both images as the area that is not able to be confirmed as the band.

As a result, it is possible to avoid erroneously extracting an area that is not a band as an area that can be confirmed as a band, which makes it possible to extract an area that can be confirmed as a band and an area that cannot be confirmed as a band with high accuracy.

When there is a plurality of areas that is able to be confirmed as the band, the band shape setting unit is configured to determine that the area that is not able to be confirmed as the band is the area that is able to be regarded as the band, on condition that the area that is not able to be confirmed as the band is located in an area between a first straight line connecting edges of one ends of the areas in a longitudinal direction of the band and extension lines of the first straight line, and a second straight line connecting edges of the other ends and extension lines of the second straight line.

Multiple bands (white lines) constituting the crosswalk are drawn on the road at predetermined intervals. Therefore, even when a part of the bands is unclear, if the other bands can be recognized (the other bands are clear), the position of the unclear band can be predicted to exist within a predetermined range. Taking advantage of this, in the present solution, when an area that cannot be confirmed as a band is located in the area between the first straight line connecting the edges of the one ends of the clear bands (an area that can be confirmed as a band) in the longitudinal direction of the bands and the extension lines of the first straight line, and the second straight line connecting the edges of the other ends and the extension lines of the second straight line, this area is regarded as the band. This makes it possible to improve the reliability of the determination that the area that cannot be confirmed as a band is regarded as the area that can be regarded as a band.

The walking support system also includes: an unclear area ratio calculation unit that calculates a ratio of an area of an area where paint is peeled off with respect to an area of an entire area of a shape as the band set by the band shape setting unit, when the area that is not able to be confirmed as the band is unclear due to peeling off of a part of the paint constituting the band; and an emergency information output unit that outputs emergency information when the ratio of the area of the area where the paint is peeled off that is calculated by the unclear area ratio calculation unit is equal to or more than a predetermined value.

According to this, with the output of the emergency information from the emergency information output unit, it is possible to take a countermeasure against the fact that most of the paint forming the band has peeled off The following can be mentioned as countermeasures in this case.

Firstly, the emergency information output unit is configured to output the emergency information to a system management server that collectively manages the walking support system.

In this case, the system management server accumulates information indicating that most of the paint forming the band has peeled off, and it is possible to accumulate the information as big data to be supplied to each walking support system that is collectively managed by the system management server. In addition, the information can be effectively used (for example, the information can be provided to a repair company and the like) as information indicating that the bands require repair.

Secondly, the emergency information output unit is configured to output the emergency information as information for notifying the pedestrian of prohibition of crossing the crosswalk.

Even if it is determined that the area that cannot he confirmed as a band is an area that can be regarded as a band, when the ratio of the unclear area is equal to or more than the predetermined value, the reliability of the determination is unlikely to be sufficiently high. Therefore, when the ratio of the unclear area is equal to or more than the predetermined value, the pedestrian is notified of prohibition of the crossing of the crosswalk.

Further, when the image acquisition unit, the crosswalk detection unit, and the band shape setting unit are each built into a white cane used by a visually impaired person as the pedestrian, the walking support system can be realized only with the white cane, so that a highly practical walking support system can be provided.

The notification unit is built in a white cane used by a visually impaired person as the pedestrian, and is configured to perform notification to the visually impaired person using the white cane by vibration or voice.

As a result, the stop notification can be appropriately performed to the visually impaired person who walks while holding the white cane.

In the present disclosure, it is determined whether the area that is not able to be confirmed as the band is an area that is able to be regarded as the band based on a relative position of the area that is not able to be confirmed as the band with respect to the area that is able to be confirmed as the band when there is the area that is not able to be confirmed as the band based on an acquired image, and a shape of the area in the image is set to a shape as the band when it is determined that the area is the area that is able to be regarded as the band. As a result, even when the band cannot be confirmed as the band only in the acquired image, a high recognition accuracy of the band can be obtained and it is possible to appropriately support walking of the pedestrian according to the position of the band.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a white cane including a walking support system according to an embodiment;

FIG. 2 is a schematic diagram showing the inside of a grip portion of the white cane;

FIG. 3 is a block diagram showing a schematic configuration of a control system of the walking support system;

FIG. 4 is a plan view around a crosswalk where a part of a white line is blurred;

FIG. 5 shows an example of an image captured by a camera in a situation where the white line closest to a pedestrian on the crosswalk is blurred;

FIG. 6 is a diagram showing a state in which the image shown in FIG. 5 is subjected to a binarization process;

FIG. 7 is a diagram showing a state in which the image shown in FIG. 6 is subjected to a white area combination process;

FIG. 8 is a diagram showing a state in which bounding boxes are set in the image shown in FIG. 7;

FIG. 9 is a diagram showing a state in which bounding boxes are set by deep learning that is performed for the image shown in FIG. 5;

FIG. 10 is a diagram illustrating a white line confirmed bounding box and a white line candidate bounding box;

FIG. 11 is a diagram illustrating a relative position comparison process;

FIG. 12 is a diagram showing an example of an image captured by a camera;

FIG. 13 is a diagram showing an example of an image captured by the camera when a visually impaired person is in a walking state heading toward a crosswalk;

FIG. 14 is a diagram showing an example of an image captured by the camera at a timing when the visually impaired person has reached the crosswalk;

FIG. 15 is a diagram showing an example of an image captured by the camera when the visually impaired person is crossing the crosswalk in a crossing state;

FIG. 16 is a diagram showing an example of an image captured by the camera when the visually impaired person crossing the crosswalk in the crossing state is walking toward a direction deviating to the right of the crosswalk;

FIG. 17 is a diagram showing an example of an image captured by the camera when the visually impaired person crossing the crosswalk in the crossing state is walking toward a. direction deviating to the left of the crosswalk;

FIG. 18 is a diagram showing a crosswalk and a traffic light that have been recognized;

FIG. 19 is a diagram illustrating dimensions of each portion of a bounding box for a white line of the crosswalk that has been recognized;

FIG. 20 is a flowchart showing a procedure for a walking support operation by the walking support system;

FIG. 21 is a plan view around a crosswalk in which a part of the white lines has a different dimension in the longitudinal direction;

FIG. 22 is a diagram showing an example of an image, captured by a camera, of a crosswalk in which a length dimension of the white line closest to a pedestrian on the crosswalk is shorter than length dimensions of other white lines;

FIG. 23 is a diagram illustrating a relative position comparison process when targeting a crosswalk in which a part of the white lines has a different dimension in the longitudinal direction;

FIG. 24 is a diagram illustrating the white line confirmed bounding box complemented by a white line shape setting process when targeting the crosswalk in which the part of the white lines has a different dimension in the longitudinal direction;

FIG. 25 is a block diagram showing a schematic configuration of a control system of the walking support system according to a modification;

FIG. 26 is a diagram showing an example of an image captured by a camera in a situation where the white line closest to a pedestrian on the crosswalk is blurred; and

FIG. 27 is a diagram showing an example of an image, captured by a camera, of a crosswalk in which the length dimension of the white line closest to the pedestrian on the crosswalk is shorter than the length dimensions of other white lines.

### DETAILED DESCRIPTION OF EMBODIMENTS

Hereinafter, embodiments of the present disclosure will be described with reference to the drawings. The present embodiment describes a case where a walking support system according to the present disclosure is built in a white cane used by a visually impaired person. In the present embodiment, a situation in which blurring has occurred on the white line (band) closest to the pedestrian on the crosswalk will be described as an example. Pedestrians in the present disclosure are not limited to visually impaired persons.

Schematic Configuration of White Cane

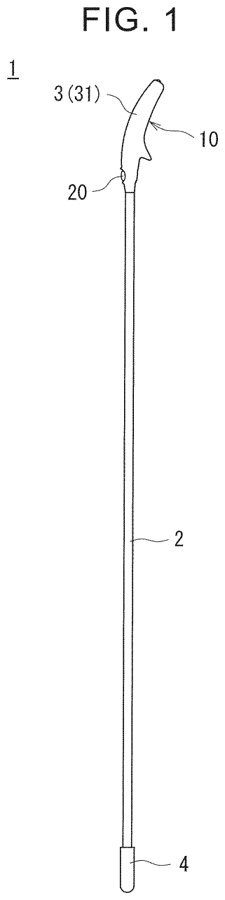

FIG. 1 is a diagram showing a white cane 1 including a walking support system 10 according to the present embodiment. As shown in FIG. 1, the white cane 1 includes a shaft portion 2, a grip portion 3, and a tip portion (ferrule) 4.

The shaft portion 2 is rod-shaped with a hollow substantially circular section, and is made of aluminum alloy, glass-fiber reinforced resin, carbon fiber reinforced resin, or the like.

The grip portion 3 is provided on a base end portion (upper end portion) of the shaft portion 2 and is configured by mounting a cover 31 made of an elastic body such as rubber. The grip portion 3 of the white cane 1 according to the present embodiment is slightly curved on the tip side (upper side in FIG. 1) in consideration of gripping ease and slipperiness when the visually impaired person (pedestrian) grips the grip portion 3.

The tip portion 4 is a substantially bottomed cylindrical member made of hard synthetic resin or the like, and is fitted onto the tip end portion of the shaft portion 2 and fixed to the shaft portion 2 by means such as adhesion or screwing. An end surface of the tip portion 4 on the tip end side has a hemispherical shape.

The white cane 1 according to the present embodiment is a straight cane that cannot be folded. However, the white cane 1 may be a cane that is foldable or expandable/contractable at an intermediate location or at a plurality of locations of the shaft portion 2.

Configuration of Walking Support System

A feature of the present embodiment is the walking support system 10 built in the white cane 1. Hereinafter, the walking support system 10 will be described.

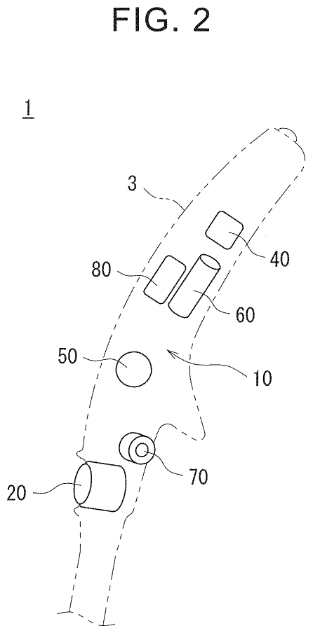

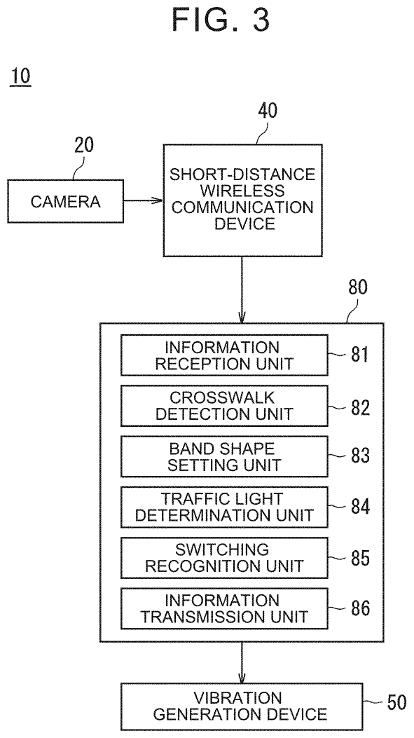

FIG. 2 is a schematic diagram showing the inside of the grip portion 3 of the white cane 1. As shown in FIG. 2, the walking support system 10 according to the present embodiment is built in the white cane 1. FIG. 3 is a block diagram showing a schematic configuration of a control system of the walking support system 10.

As shown in these figures, the walking support system 10 includes a camera (image acquisition unit) 20, a short-distance wireless communication device 40, a vibration generation device (notification unit) 50, a battery 60, a charging socket 70, a control device 80, and the like.

The camera 20 is embedded in a front surface (a surface facing the traveling direction of the visually impaired person) of the grip portion 3 on a root portion of the grip portion 3 and captures an image of the front in the traveling direction (front in the walking direction) of the visually impaired person. The camera 20 is configured by, for example, a charge coupled device (CCD) or a complementary metal oxide semiconductor (CMOS). The configuration and the arrangement position of the camera 20 are not limited to those described above, and the camera 20 may be embedded in the front surface (a surface facing the traveling direction of the visually impaired person) of the shaft portion 2, for example.

As a feature of the camera 20, the camera 20 is configured as a wide-angle camera capable of acquiring an image of the front in the traveling direction of the walking visually impaired person, the image including both a white line closest to the visually impaired person of the white lines of the crosswalk and the traffic light located in front of the visually impaired person (for example, a pedestrian traffic light) when the visually impaired person reaches the crosswalk. That is, the camera 20 is configured to be capable of capturing an image of both the frontmost white line of the crosswalk near the feet of the visually impaired person (at a position slightly ahead of the feet) at the time when the visually impaired person has reached a position before the crosswalk, and the traffic light installed on a point at the crossing destination. The view angle required for the camera 20 is appropriately set so that an image including both the white line (white line of the crosswalk) closest to the visually impaired person and the traffic light can be acquired as described above.

The short-distance wireless communication device 40 is a wireless communication device for performing short-distance wireless communication between the camera 20 and the control device 80. For example, the short-distance wireless communication device 40 is configured to perform short-distance wireless communication between the camera 20 and the control device 80 by known communication means such as Bluetooth (registered trademark) to wirelessly transmit information of the image captured by the camera 20 to the control device 80.

The vibration generation device 50 is arranged above the camera 20 in the root portion of the grip portion 3. The vibration generation device 50 vibrates in response to the operation of a built-in motor and transmits the vibration to the grip portion 3, thereby various notifications can be performed toward the visually impaired person gripping the grip portion 3. Specific examples of the notifications performed to the visually impaired person through the vibration of the vibration generation device 50 will be described later.

The battery 60 is configured by a secondary battery that stores electric power for the camera 20, the short-distance wireless communication device 40, the vibration generation device 50, and the control device 80.

The charging socket 70 is a part where a charging cable is connected when storing electric power in the battery 60. For example, the charging cable is connected when the visually impaired person charges the battery 60 from a household power source at home.

The control device 80 includes, for example, a processor such as a central processing unit (CPU), a read only memory (ROM) that stores a control program, a random access memory (RAM) that stores data temporarily, an input/output port, and the like.

The control device 80 includes, as functional units realized by the control program, an information reception unit 81, a crosswalk detection unit 82, a band shape setting unit 83, a traffic light determination unit 84, a switching recognition unit 85, and an information transmission unit 86. An outline of the functions of each of the above units will be described below.

The information reception unit 81 receives information of the image captured by the camera 20 from the camera 20 via the short-distance wireless communication device 40 at a predetermined time interval.

The crosswalk detection unit 82 recognizes the crosswalk in the image from the information of the image received by the information reception unit 81 (information of the image captured by the camera 20) and detects the front edge position of the white line closest to a pedestrian (visually impaired person) of the white lines of the crosswalk. The front edge position of the white line closest to the pedestrian detected here is the front edge position of the white line closest to the pedestrian in the shape of the white line (band) set by the band shape setting unit 83 described later (the front edge position of the white line in consideration of the fact that blurring has occurred on the white line as described later). That is, by receiving the information (information on the shape of the white line) from the hand shape setting unit 83, the crosswalk detection unit 82 recognizes the front edge position of the white line closest to the pedestrian and outputs a signal corresponding to the edge position.

The band shape setting unit 83 is a functional unit characterized in the present embodiment, and can extract an area that can be confirmed as a white line constituting the crosswalk and an area that cannot be confirmed as a white line constituting the crosswalk based on the information of the image captured by the camera 20. When there is an area that cannot be confirmed as a white line, the band shape setting unit 83 determines whether the area that cannot be confirmed as a white line is an area that can be regarded as a white line based on the relative position of the area that cannot be confirmed as a white line with respect to the area that can be confirmed as a white line. When the band shape setting unit 83 determines that the area is an area that can be regarded as a white line, the band shape setting unit 83 sets the shape of the area in the image to the shape as a white line (the original shape of the white line). Then, the set white line information is transmitted to the crosswalk detection unit 82 to be used for recognition operation of the crosswalk performed by the crosswalk detection unit 82 (particularly, recognition operation of the front edge position of the white line closest to the pedestrian). Hereinafter, a specific description will be given.

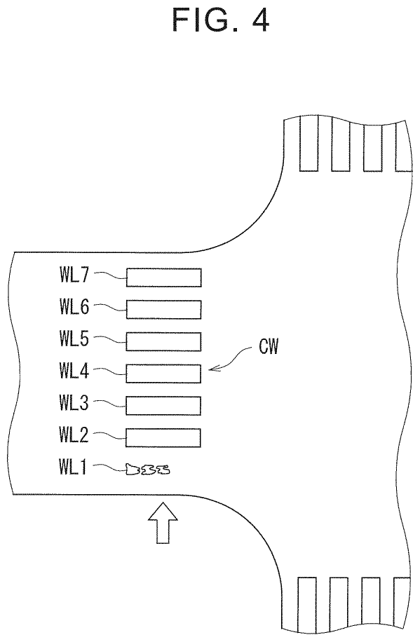

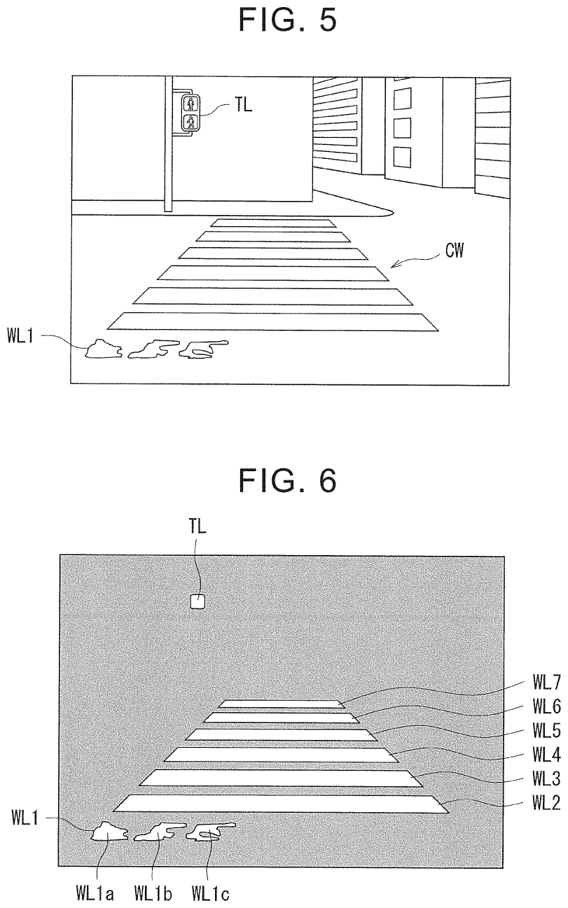

The recognition of the crosswalk is performed by detecting the white part (high-brightness area) in the acquired image. It is thus difficult to accurately recognize the white line when the white line of the crosswalk is blurred (a state where a part of the paint forming the white line is peeled off) or covered (a state where a part of the white line is covered with an object of another color, for example, covered with fallen leaves or mud). Therefore, there is a possibility that walking support cannot be accurately provided to pedestrians (visually impaired persons). In particular, when the white line closest to the pedestrian is blurred or covered, it is difficult to perform the stop notification at an appropriate position before the crosswalk. FIG. 4 is a plan view of around a crosswalk CW where a part of the white line is blurred. The arrow in FIG. 4 indicates the traveling direction of the visually impaired person with respect to the crosswalk CW (direction approaching the crosswalk CW). FIG. 5 is a diagram showing an example of an image captured by the camera 20 in a situation where a white line WU closest to the pedestrian on the crosswalk CW is blurred. When such an image is acquired, the white line WLI closest to the pedestrian cannot be confirmed as the white line, and it is difficult to accurately recognize the white line. It should be noted that the situation where it is difficult to accurately recognize the white line is not limited to the case where the white line is blurred or covered as described above. It may also be difficult to accurately recognize the white line depending on the imaging direction of the camera 20 and the weather (especially the situation where there is a puddle or snow on the road surface).

Therefore, in the present embodiment, as described above, when there is an area that cannot be confirmed as a white line due to blurring or the like, the band shape setting unit 83 determines whether the area that cannot be confirmed as a white line is an area that can be regarded as a white line. When the band shape setting unit 83 determines that the area is an area that can be regarded as a white line, the band shape setting unit 83 sets the shape of the area in the image to the shape as a white line (more specifically, a shape as a bounding box surrounding the white line).

As the information processes in the band shape setting unit 83 for that purpose, a binarization process, a white area combination process, a bounding box setting process, a bounding box comparison process, a white area storage process, a relative position comparison process, and white line shape setting process are performed in order. Hereinafter, these processes will be specifically described.

Binarization Process

In the binarization process, monochrome (black and white) binarization is performed for the image captured by the camera 20. FIG. 6 is a diagram showing a state in which the image shown in FIG. 5 is subjected to the binarization process. As shown in FIG. 6, in the binarization process, an area in the image Where the brightness is equal to or higher than a threshold value and an area where the brightness is lower than the threshold value are distinguished, and only the area where the brightness is equal to or higher than the threshold value is extracted. In FIG. 6, the white area is the area where the brightness is equal to or higher than the threshold value, and the gray area is the area where the brightness is lower than the threshold value. Here, the white lines WL2 to WL7 in which blurring has not occurred, a part of the white line WL1 in which blurring has occurred (the part remaining as white, that is, the part with the reference signs WL1a, WL1b, WL1c in FIG. 6), and the lit area in the pedestrian traffic light TL are extracted as areas where the brightness is equal to or higher than the threshold value. At this point, it has not yet been confirmed that the part of the white line WL1 (parts WL1a, WL1b, WL1c remaining as white is a part of the white line WL1.

White Area Combination Process

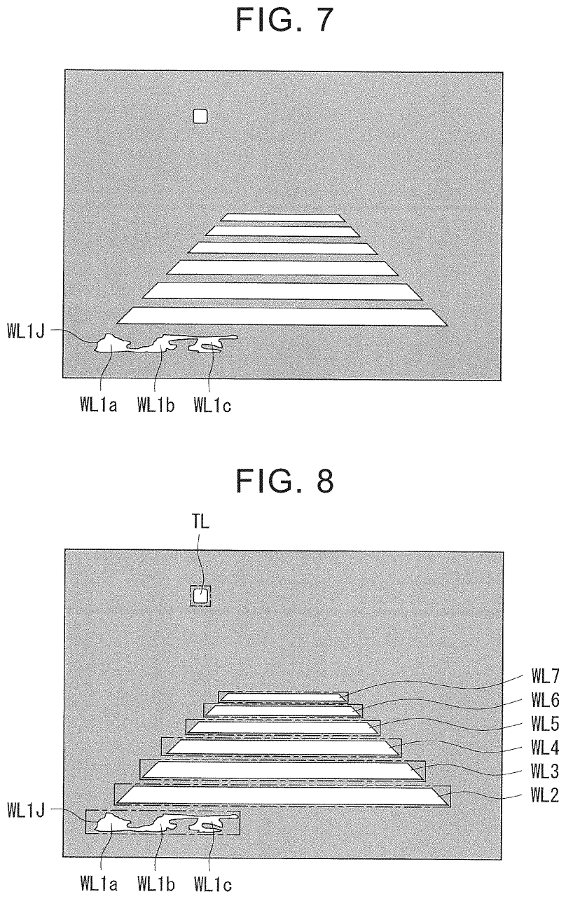

In the white area combination process, among the extracted areas (areas with a brightness equal to or higher than the threshold value), areas where the distance dimension of adjacent areas is less than a predetermined dimension are combined. FIG. 7 is a diagram showing a state in which the image shown in FIG. 6 is subjected to the white area combination process. The detection of the distance dimension between the extracted areas is performed, for example, by measuring the number of pixels corresponding to this distance in the image. In FIG. 7, each white part (each white part WL1a, WL1b, WL1c in FIG. 6) constituting the white line WL1 is connected to each other to form a continuous white part. Hereinafter, this combined white part is referred to as a combined area WL1J.

Bounding Box Setting Process

In the bounding box setting process, the bounding boxes are set for the white lines WL2 to WL7 in which blurring has not occurred, and the bounding box is also set for the combined area WL1J. In addition, the bounding box is set for the lit area in the pedestrian traffic light TL. FIG. 8 is a diagram showing a state in which the bounding boxes (see long-dashed short-dashed lines in the figure) are set in the image shown in FIG. 7. The horizontal length dimension of the bounding box set for the combined area WL1J substantially coincides with the length dimension between the right end portion and the left end portion of the combined area WL1J. Further, the vertical length dimension of the bounding box set for the combined area WL1J substantially coincides with the length dimension between the upper end portion and the lower end portion of the combined area WL1J. By setting the bounding box in this way, regardless of the shape of each white part WL1a, WL1b, WL1c (even if the end portions are peeled off so as to be missing), a bounding box (square frame) that surrounds the entirety of these white parts WL1a, WL1b, WL1c can be set. When the size and the position of the bounding box set in this way can be reliably excluded from those of the candidates for the crosswalk CW, the bounding box may be removed as noise.

Bounding Box Comparison Process

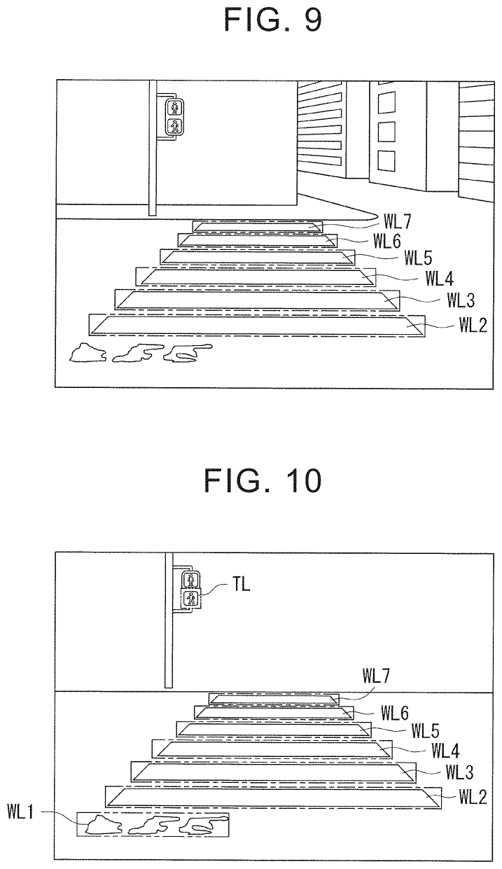

In the bounding box comparison process, the bounding boxes set in the bounding box setting process (the bounding boxes set for the white lines WL2 to WL7 in which blurring has not occurred, the bounding box set for the combined area WL1J, and the bounding box set for the lit area in the pedestrian traffic light TL) are compared with the bounding boxes of the white lines of the crosswalk CW, which is obtained by deep learning performed for the image captured by the camera 20. That is, the sizes and the positions of these bounding boxes are compared to extract the bounding boxes that match each other and the bounding boxes that do not match each other. Here, the bounding boxes of the white lines of the crosswalk CW obtained by deep learning are set for the white lines confirmed using data of the white lines with pre-annotated width dimensions, length dimensions, and the like (labeled data of the white lines, that is, teacher data for recognizing the white lines by deep learning). FIG. 9 is a diagram showing a state in which bounding boxes (see long-dashed short-dashed lines in the figure) are set by deep learning that is performed for the image shown in FIG. 5.

By comparing these bounding boxes, the bounding boxes set for the white lines WL2 to WL7 match each other. On the other hand, although the bounding boxes set in the bounding box setting process include the bounding box for the combined area WL1J and the bounding box set for the lit area in the pedestrian traffic light TL, the bounding boxes set by deep learning do not include the bounding box for the combined area WL1J and the bounding box set for the lit area in the pedestrian traffic light TL. Therefore, the bounding box for the combined area WL1J and the bounding box set for the lit area in the pedestrian traffic light TL are extracted as non-matching bounding boxes (non-matching with the bounding boxes set by deep learning). In the following description, the matching bounding boxes are referred to as white line confirmed bounding boxes (a band confirmed area and an area that is able to be confirmed as a band in the present disclosure), and the non-matching bounding boxes are referred to as white line candidate bounding boxes (an area that is not able to be confirmed as a band in the present disclosure). In FIG. 10, the white line confirmed bounding boxes are indicated by long-dashed short-dashed lines, and the white line candidate bounding boxes are indicated by long-dashed double-short-dashed lines.

White Area Storage Process

In the white area storage process, the information obtained in the bounding box comparison process is stored in the RAM. That is, the information of the white line confirmed bounding boxes and the white line candidate bounding boxes are stored.

Relative Position Comparison Process

In the relative position comparison process, the relative position of the white line candidate bounding box with respect to the white line confirmed bounding box is obtained, and it is determined whether the white line candidate bounding box is a bounding box that can be regarded as a white line.

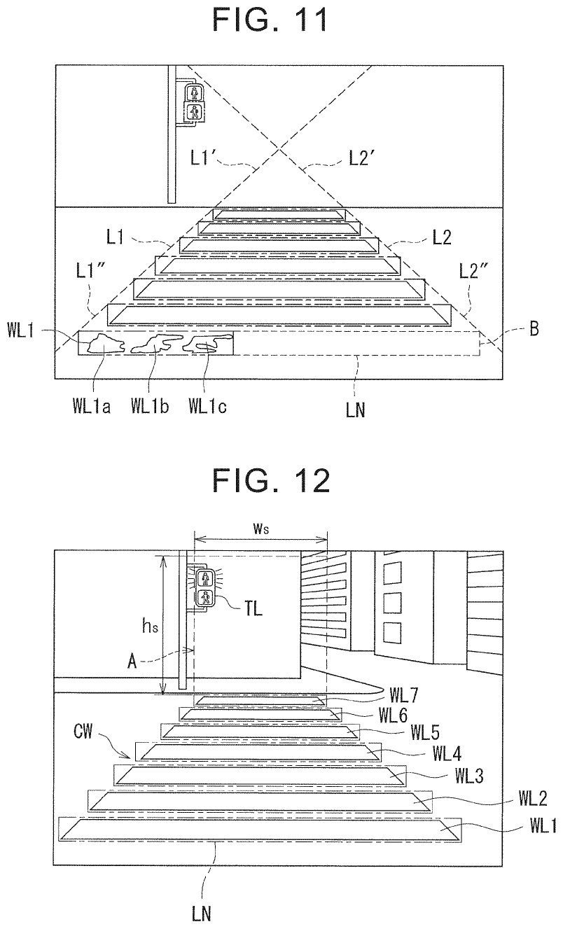

This relative position comparison process will be specifically described. FIG. 11 is a diagram illustrating the relative position comparison process. As shown in FIG. 11, it is determined whether the white line candidate bounding boxes (bounding boxes indicated by the long-dashed double-short-dashed lines in the figure) are located in an area between a straight line L1 and extension lines L1′, L1″ of the straight line L1, and a straight line L2 and extension lines L2′, L2″ of the straight line L2. The straight line L1 connects edges of one ends in the longitudinal direction (right-left direction in FIG. 11) of each white line confirmed bounding box (bounding boxes indicated by the long-dashed short-dashed lines in the figure) and the straight line L2 connects edges of the other ends thereof. As shown in FIG. 11, in the image, the white line near the visually impaired person is displayed large, and the white line far from the visually impaired person is displayed small. Therefore, each straight line L1, L1′, L1″, L2, L2′, L2″ is drawn as an inclined line having a predetermined inclination angle with respect to the vertical direction of the image.

In FIG. 11, among the plurality of white line candidate bounding boxes, the bounding box set for the lit area in the pedestrian traffic light TL does not exist in the area between the straight lines L1, L1′, L1″, L2, L2′, L2″ (specifically, between the straight lines L1′ and L2′). Therefore, this white line candidate bounding box is determined to be a bounding box that is not regarded as a white line. On the other hand, among the plurality of white line candidate bounding boxes, the bounding box for the white parts WL1a, WL1b, WL1c exists in the area between the straight lines L1, L1′, L1″, L2, L2′, L2″ (specifically, between the straight lines L1″ and L2″). Therefore, this white line candidate bounding box is determined to be a bounding box that is regarded as a white line.

With the above operation, the areas that can be confirmed as a white line in the image (the bounding boxes corresponding to the white lines) are the bounding boxes set for the white lines WL2 to WL7 described above and the white line candidate bounding box existing in the area between the straight lines L1, L1′, L1″, L2, L2′, L2″ (the bounding box for the white parts WL1a, WL1b, WL1c).

White Line Shape Setting Process

In the white line shape setting process, the bounding box that is regarded as the white line in the relative position comparison process (bounding box for the white parts WL1a, WL1b, WL1c) is expanded and corrected to the bounding box corresponding to the original shape of the white line WL1. Specifically, the length dimension of the bounding box (dimension in the right-left direction in the figure) is extended to a position corresponding to each of the straight lines L1″ and L2″ in the length direction of the bounding box. As a result, the bounding box of the white line WL1 is expanded to the position indicated by the dashed line B in FIG. 11. FIG. 11 shows a case where the bounding box is expanded to the right, but when the white parts WL1a, WL1b, and WL1c exist only in the central portion (the central portion in the longitudinal direction) of the white line WL1, the bounding box is expanded to both the right and left.

The information of the bounding boxes set in the band shape setting unit 83 is transmitted to the crosswalk detection unit 82, and the crosswalk detection unit 82 detects the lower end position (see LN in FIG. 11) of the bounding box closest to the pedestrian among these bounding boxes. This lower end position corresponds to the “edge position of the crosswalk closer to the pedestrian” in the present disclosure. In the present embodiment, a bounding box is set for each white line WL1 to WL7 and the lower end position LN of the bounding box positioned on the lowest side in the image is defined as the “edge position of the crosswalk closer to the pedestrian”. However, of the white lines WL1 to WL7 that have been confirmed in the image, the lower end position of the white line WL1 positioned on the lowest side may be defined as the “edge position of the crosswalk closer to the pedestrian”, without setting the bounding boxes.

As described later, the bounding box is used for specifying a stop position of the visually impaired person, specifying a position of a traffic light TL, specifying the traveling direction of the visually impaired person when the visually impaired person crosses the crosswalk CW, determining crossing completion of the crosswalk CW, and the like. Details of the above will be described later.

The traffic light determination unit 84 determines whether the state of the traffic light TL is either a red light (stop instruction state) or a green light (crossing permission state) from the information of the image received by the information reception unit 81. In estimating an existing area of the traffic light TL in the image received by the information reception unit 81, of the bounding boxes set for the white lines WL1 to WL7 that have been recognized as described above, the coordinates of the farthest bounding box in the image is specified, and as shown in FIG. 12, a quadrangle (a quadrangle having a width dimension of wₛ and a height dimension of hₛ) that contacts the upper side of the above bounding box (the bounding box set for the white line WL7 positioned at the farthest position, of the recognized white lines WL1 to WL7) is defined. With the quadrangle defined as an area A of the traffic light TL (existing area of the traffic light TL), a cropped range is output. At this time, the cropped range may be a square or a rectangle. Although the dimensions wₛ and hₛ can be set to any values, the dimensions wₛ and hₛ are set empirically or experimentally so as to include the arrangement position of the traffic light TL. A general object detection algorithm or a general rule-based algorithm is used for determining the state of the traffic light (color detection) performed by the traffic light determination unit 84.

The switching recognition unit 85 recognizes that the state of the traffic light TL determined by the traffic light determination unit 84 has switched from the red light to the green light. Upon recognizing this switching of the traffic light, the switching recognition unit 85 transmits a switching signal to the information transmission unit 86. The switching signal is transmitted from the information transmission unit 86 to the vibration generation device 50. In conjunction with receiving the switching signal, the vibration generation device 50 vibrates in a predetermined pattern, thereby performing a notification for permitting crossing of the crosswalk (crossing start notification) to the visually impaired person, due to the fact that the traffic light TL has switched from the red light to the green light.

Walking Support Operation

Next, a walking support operation performed by the walking support system 10 configured as described above will be described. First, an outline of the present embodiment will be described.

### Outline of Present Embodiment

Here, a time during walking of the visually impaired person is indicated as t∈ [0,T] and a variable representing the state of the visually impaired person is indicated as s∈ R^{T}. The state variable at time t is represented by an integer of sₜ∈[0,1,2], each of which representing a walking state (sₜ=0), a stop state (sₜ=1), and a crossing state (sₜ=2). For the walking state, for example, a state where the visually impaired person is walking toward an intersection (an intersection including the traffic light TL and the crosswalk CW) is assumed. For the stop state, a state where the visually impaired person has reached a position before the crosswalk CW and is stopped (not walking) while waiting for the traffic light to change (waiting for the traffic light to switch from the red light to the green light) is assumed. For the crossing state, a state where the visually impaired person is crossing the crosswalk CW is assumed.

The present embodiment proposes an algorithm for obtaining an output y∈R^{T} for the purpose of supporting walking of the visually impaired person when the image Xₜ∈R^{w0×h0} (w₀ and h₀ each represent the longitudinal image size and the lateral image size) captured by the camera 20 at time t is input. Here, the output for supporting walking of the visually impaired person is represented by an integer of yₜ∈[1,2,3,4], each of which representing a stop instruction (yₜ=1), a walking instruction (yₜ=2), a right deviation warning (yₜ=3), and a left deviation warning (yₜ=4). In the following description, the stop instruction may be referred to as the stop notification. Further, the walking instruction may be referred to as the walking notification or the crossing notification. These instructions (notifications) and warnings are performed to the visually impaired person by the vibration pattern of the vibration generation device 50. The visually impaired person knows in advance the relationship between the instructions (notifications) and the warnings and the vibration patterns of the vibration generation device 50, and grasps the type of the instruction and the warning by sensing the vibration pattern of the vibration generation device 50 from the grip portion 3.

As described later, there are a function for determining the transition of a parameter s representing the state of the visually impaired person (hereinafter referred to as state transition function) f₀, f₁, f₂, and a state transition function f₃ for determining a deviation from the crosswalk CW (deviation in the right and left direction). These state transition functions f₀ to f₃ are stored in the ROM. Specific examples of the state transition functions f₀ to f₃ will be described later.

Outline of Output Parameter y and State Transition Function fᵢ

The above-mentioned output yₜ∈[1,2,3,4], for supporting walking of the visually impaired person will be described,

As described above, as the output yₜ, for the purpose of supporting walking of the visually impaired person, there are four types of outputs, namely, the stop instruction (yₜ=1), the walking instruction (yₜ=2), the right deviation warning (yₜ=3), and the left deviation warning (yₜ=4).

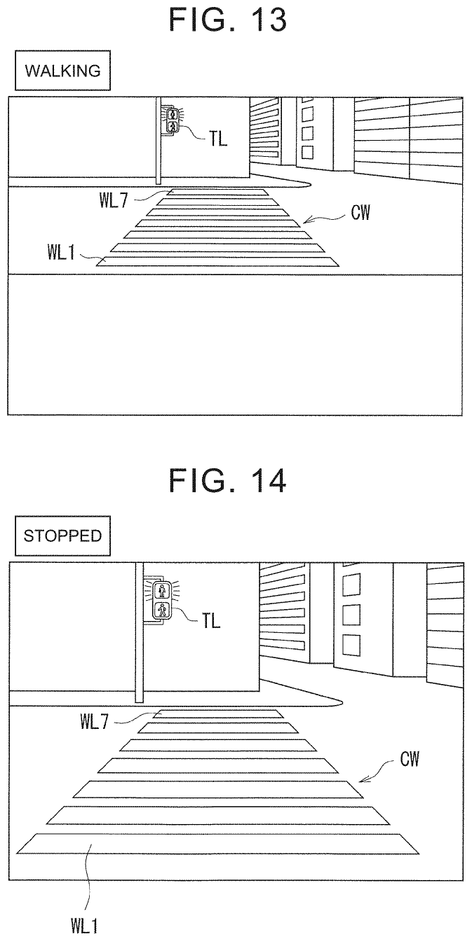

The stop instruction (yₜ=1) is an instruction for notifying the visually impaired person to stop walking at the time when the walking visually impaired person has reached a position before the crosswalk CW. For example, when the image captured by the camera 20 indicates a state shown in FIG. 13 (a figure showing an example of the image captured by the camera 20 when the visually impaired person is in the walking state heading toward the crosswalk CW), the distance from the crosswalk CW is relatively long, so that the stop instruction (yₜ=1) is not performed and the visually impaired person is caused to continue the walking state (sₜ=0). However, when the image captured by the camera 20 indicates a state shown in FIG. 14 (a figure showing an example of the image captured by the camera 20 at a timing when the visually impaired person has reached the crosswalk CW), it is a timing that the visually impaired person has reached a position before the crosswalk CW, so that the stop instruction (yₜ=1) is output and the visually impaired person is notified to stop walking. The determination on whether the condition for performing the stop instruction (yₜ=1) is satisfied (the determination based on a calculation result of the state transition function) will be described later.

The walking instruction (yₜ=2) is an instruction for notifying the visually impaired person to walk (cross the crosswalk CW) when the traffic light TI, switches from the red light to the green light. For example, when the visually impaired person is in the stop state (sₜ=1) before the crosswalk CW and the traffic light TL switches from the red light to the green light based on the image captured by the camera 20, the walking instruction (yₜ=2) is output to notify the visually impaired person to start crossing the crosswalk CW. The determination on whether the condition for performing the walking instruction (yₜ=2) is satisfied (the determination based on a calculation result of the state transition function) will also be described later.

In the present embodiment, the timing for performing the walking instruction (yₜ=2) is the timing at which the state of the traffic light TL is switched from the red light to the green light. That is, the walking instruction (yₜ=2) is not performed even if the traffic light TL is already at the green light when the visually impaired person reaches the crosswalk CW, and the walking instruction (yₜ=2) is performed at the timing at which the traffic light TL is switched to the green light after the traffic light TL once switches to the red light. This makes it possible to secure sufficient time during which the traffic light TL is at the green light when the visually impaired person crosses the crosswalk CW, and makes it difficult to cause a situation where the traffic light TL switches from the green light to the red light while the visually impaired person is crossing the crosswalk CW.

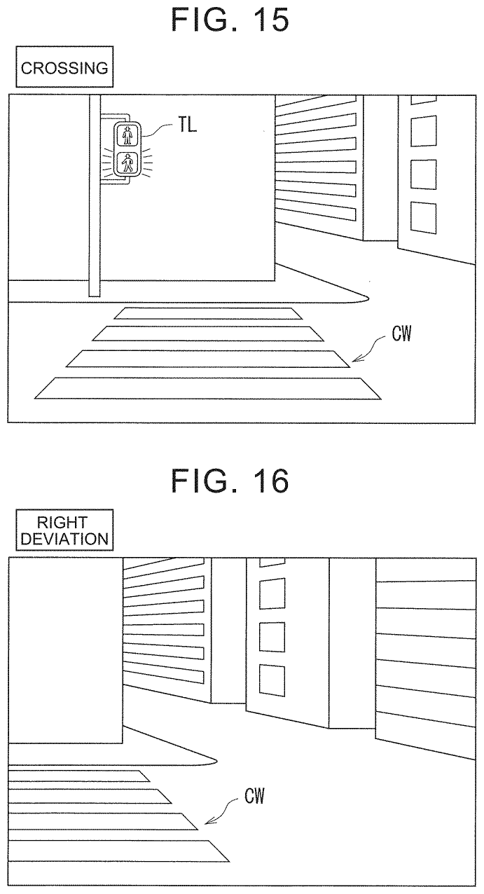

The right deviation warning (y=3) is a notification for warning the visually impaired person that there is a risk of deviating to the right from the crosswalk CW, when the visually impaired person crossing the crosswalk CW is walking in a direction deviating to the right from the crosswalk CW. For example, in a state where the image captured by the camera 20 is in a state shown in FIG. 15 (a figure showing an example of the image captured by the camera 20 when the visually impaired person is crossing the crosswalk CW in the crossing state) and in a situation where the visually impaired person is crossing the crosswalk CW in the crossing state (sₜ=2), when the image captured by the camera 20 changes to a state shown in FIG. 16 (a figure showing an example of the image captured by the camera 20 when the visually impaired person crossing the crosswalk CW in the crossing state is walking in the direction deviating to the right of the crosswalk CW), the visually impaired person is walking in the direction deviating to the right from the crosswalk CW, so that the right deviation warning (yₜ=3) is output to warn the visually impaired person.

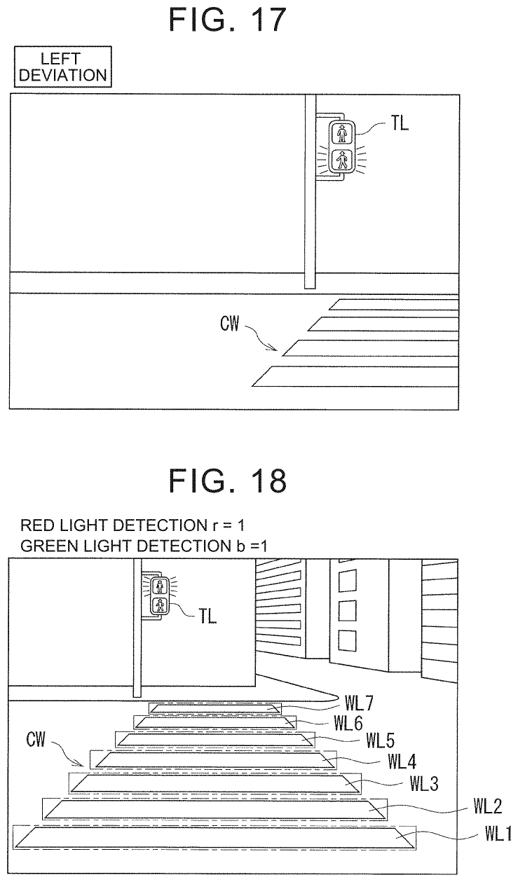

The left deviation warning (yₜ=4) is a notification for warning the visually impaired person that there is a risk of deviating to the left from the crosswalk CW, when the visually impaired person crossing the crosswalk CW is walking in a direction deviating to the left from the crosswalk CW. For example, in a state where the image captured by the camera 20 is in the state shown in FIG. 15 and in a situation where the visually impaired person is crossing the crosswalk CW in the crossing state (sₜ=2), when the image captured by the camera 20 changes to a state shown in FIG. 17 (a figure showing an example of the image captured by the camera 20 when the visually impaired person crossing the crosswalk CW in the crossing state is walking in the direction deviating to the left of the crosswalk CW), the visually impaired person is walking in the direction deviating to the left from the crosswalk CW, so that the left deviation warning (yₜ=4) is output to warn the visually impaired person.

The determination on whether the conditions for performing the right deviation warning (yₜ=3) and the left deviation warning (yₜ=4) are satisfied (the determination based on a calculation result of the state transition function) will also be described later.

Feature Amount Used for Walking Support

Next, the feature amount used for walking support for the visually impaired person will be described. In order to appropriately perform the various notifications to the visually impaired person, such as the stop notification of walking before the crosswalk CW and the subsequent crossing start notification, it is essential that the position of the crosswalk CW (the position of the frontmost white line WL1 of the crosswalk CW) and the state of the traffic light TL (whether the traffic light TL is a green light or a red light) are accurately recognized via the information from the camera 20. That is, it is necessary to construct a model expression that reflects the position of the white line WL1 and the state of the traffic light TL, and to be able to grasp the current situation of the visually impaired person according to this model expression.

In the following description of the feature amount and the state transition function, as a basic operation of the walking support system 10, a case where no blurring has occurred on the white lines WL1 to WL7 of the crosswalk CW and the crosswalk CW is recognized (at least the white line WL1 positioned in the frontmost position is recognized) in the image acquired by the camera 20 will be described.

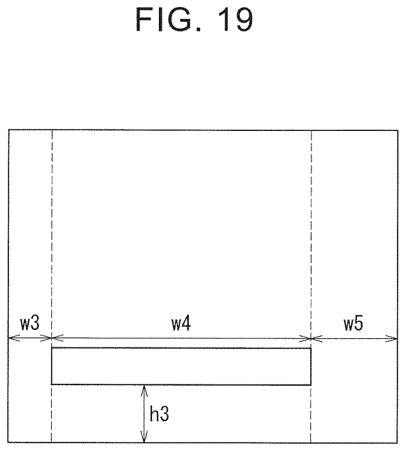

FIGS. 18 and 19 show an outline of the feature amounts [w₃, w₄, w₅, h₃, r, b]^{T}∈R⁶ used for the walking support for the visually impaired person. The characters r and b represent the detection results (0: undetected, 1: detected) of the state (red light and green light) of the traffic light TL, respectively. When detecting the state of the traffic light TL, as described above, the area A surrounded by the dashed line in FIG. 12 is extracted to recognize the state of the traffic light TL. The characters w₃, w₄, w₅, h₃ are defined as shown in FIG. 19 using a bounding box for the white line WL1 positioned in the frontmost position of the white lines WL1 to WL7 of the crosswalk CW recognized by the crosswalk detection unit 82. That is, w₃ is the distance from the left end of the image to the left end of the bounding box (corresponding to the left end of the white line WL1), w₄ is the width dimension of the bounding box (corresponding to the width dimension of the white line WL1), w₅ is the distance from the right end of the image to the right end of the bounding box (corresponding to the right end of the white line WL1), and h₃ is the distance from the lower end of the image to the lower end of the bounding box (corresponding to the front edge of the white line WL1).

When the function to detect the crosswalk CW and the traffic light TL using deep learning is defined as g and the bounding boxes of the crosswalk CW and the traffic light TL that have been predicted using the image Xₜ∈R^{w0×h0} captured by the camera 20 at time t are expressed as g(Xₜ), a feature amount required to support walking of the visually impaired person can be expressed by the following expression (1).

Expression 1

j(t)={w₃^{t}, w₄^{t}, w₅^{t}, h₃^{t}, r^{t}, b^{t}}^{T}=ϕ·g(Xₜ) (1)

Here,

Expression 2

ϕ:R^{p1/4} [symbol] R⁶ (2)

is an operator for extracting the feature amount j(t) and for performing post-processing on g(Xₜ), and p1 is the maximum number of bounding boxes per frame.

State Transition Function

Next, the state transition function will be described. As described above, the state transition function is used to determine whether the condition for notifying each of the stop instruction (yₜ=1), the walking instruction (yₜ=2), the right deviation warning (yₜ=3), and the left deviation warning (yₜ=4) is satisfied,

The state amount (state variable) sₜ₊₁ at time t+1 can be expressed by the following expression (3) using the time history information J={j(0), j(1), . . . j(t)} with respect to the feature amount of the crosswalk CW, the current state amount (state variable) sₜ, and the image Xₜ₊₁ captured at time t+1.

Expression 3

sₜ₊₁=f(J, sₜ, Xₜ₊₁) (3)

The state transition function f in expression (3) can be defined as the following expression (4) according to the state amount at the current time.

$$\begin{matrix}Expression 4 & \\ f ( J , {s}_{t} , {X}_{t + 1} ) = \{ \begin{matrix}{f}_{0} ( J , {X}_{t + 1} ) & if {s}_{t} = 0 ( Walking ) \\ {f}_{1} ( J , {X}_{t + 1} ) & if {s}_{t} = 1 ( Stop ) \\ {f}_{2} ( J , {X}_{t + 1} ) & if {s}_{t} = 2 ( Crossing )\end{matrix} & ( 4 )\end{matrix}$$

In other words, with the transition of walking for the visually impaired person being repeated as follows: walking (for example, walking toward the crosswalk CW)→stop (for example, stopping before the crosswalk CW)→crossing (for example, crossing the crosswalk CW)→walking (for example, walking after the crossing completion of the crosswalk CW), the state transition function for determining whether the condition for performing the stop instruction (yₜ=1) to the visually impaired person in the walking state (sₜ=0) is satisfied is f₀(J, Xₜ₊₁), the state transition function for determining whether the condition for performing the crossing (walking) instruction (yₜ=2) to the visually impaired person in the stop state (sₜ=1) is satisfied is f₁(J, Xₜ₊₁), and the state transition function for determining whether the condition for notifying the visually impaired person in the crossing state (sₜ=2) of walking (completion of crossing) is satisfied is f₂(J, Xₜ₊₁). Further, the state transition function for determining whether the condition for warning the visually impaired person in the crossing state (Sₜ=2) of deviation from the crosswalk CW is satisfied is f₃(J, Xₜ₊₁).

Hereinafter, the stale transition function corresponding to each stale amount (state variable) will be specifically described.

State Transition Function Applied in Walking State

The state transition function f₀(j, Xₜ₊₁) used when the state amount at the current time is the walking state (sₜ=0) can be expressed by the following expressions (5) to (7) using the feature amount in expression (1).

$$\begin{matrix}Expression 5 & \\ {f}_{0} ( J , {X}_{t + 1} ) = H ( {α}_{1} - {h}_{3}^{t + 1} ) H ( {w}_{4}^{t + 1} - {α}_{2} ) \times δ ( {\sum }_{t = t - t 0}^{t} H ( {α}_{1} - {h}_{3}^{t} ) H ( {w}_{4}^{t} - {α}_{2} ) ) & ( 5 )\end{matrix}$$

$$\begin{matrix}Expression 6 & \\ {w}_{4}^{t + 1} = {I}_{2}^{T} \{ ϕ ∘ g ( {X}_{t + 1} ) \} & ( 6 )\end{matrix}$$

$$\begin{matrix}Expression 7 & \\ {h}_{3}^{t + 1} = {I}_{4}^{T} \{ ϕ ∘ g ( {X}_{t + 1} ) \} & ( 7 )\end{matrix}$$

Here, H is a Heaviside function and δ is a Delta function. Further, α₁ and α₂ are parameters used for the determination criteria, and t0 is a parameter for specifying the past state to he used. Further, I₂={0,1,0,0,0,0}^{T} and I₄={0,0,0,1,0,0}^{T} hold.

When expression (5) is used, “1” is obtained only when the conditions of α₁>h₃ and w₄>α₂ are not satisfied in the past time t0 and are satisfied for the first time at time t+1, and otherwise “0” is obtained. That is, when α₁>h₃ is satisfied, it is determined that the white line WL1 (the lower end of the hounding box of the white line) positioned in the frontmost position of the crosswalk CW is positioned at the feet of the visually impaired person, and when w₄>α₂ is satisfied, it is determined that the white line WL1 extends in a direction orthogonal to the traveling direction of the visually impaired person (the width dimension of the bounding box of the white line exceeds a predetermined dimension). When both α₁>h₃ and w₄>α₂ are satisfied, “1” is obtained.

When “1” is obtained in expression (5) in this way, it is assumed that the condition for performing the stop instruction (yₜ=1) is satisfied, and the stop instruction (for example, a stop instruction for walking before the crosswalk CW, that is, the stop notification) is performed to the visually impaired person in the walking state.

Further, in the present embodiment, in addition to the condition that the crosswalk CW is at the feet of the visually impaired person (α₁>h₃), a restriction on the width of the detected crosswalk CW (w₄>α₂) is added, to prevent a detection error in the case where a crosswalk other than the crosswalk CW located in the traveling direction of the visually impaired person (such as a crosswalk extending in the direction orthogonal to the traveling direction of the visually impaired person at an intersection) is included in the image Xₜ₊₁. That is, even when there is a plurality of crosswalks having different crossing directions at a road intersection or the like, the crosswalk CW that the visually impaired person should cross (the crosswalk CW with the white line WL1 extending in the direction intersecting the direction in which the visually impaired person should cross, so that the width dimension of the white line WL1 is recognized to be relatively wide) and other crosswalks (crosswalks where the width dimension of the white line is recognized to be relatively narrow) can he clearly distinguished from each other, making it possible to accurately perform the crossing start notification to the visually impaired person with high accuracy.

State Transition Function Applied in Stop State

The state transition function f₁(j, Xₜ₊₁) used when the state amount at the previous time is the stop state (sₜ=1) can be expressed by the following expressions (8) to (10).

$$\begin{matrix}Expression 8 & \\ {f}_{1} ( J , {X}_{t + 1} ) = {b}^{t + 1} δ ( {\sum }_{t = t - t 0}^{t} {r}^{t} ) & ( 8 )\end{matrix}$$

$$\begin{matrix}Expression 9 & \\ {b}^{t + 1} = {I}_{6}^{T} \{ ϕ ∘ g ( {X}_{t + 1}^{′} ) \} & ( 9 )\end{matrix}$$

$$\begin{matrix}Expression 10 & \\ {r}^{t + 1} = {I}_{6}^{T} \{ ϕ ∘ g ( {X}_{t + 1}^{′} ) \} & ( 10 )\end{matrix}$$

Here, X′ₜ₊₁ is obtained by trimming and enlarging the image from Xₜ₊₁. That is, the recognition accuracy of the traffic light TL is sufficiently improved in the image X′ₜ₊₁. Further, I₅={0,0,0,0,1,0}^{T} and I₆={0,0,0,0,0,1}^{T} hold.

In expression (8), “1” is obtained only when the green light is detected for the first time at time t+1 after the red light is detected in the past time to, and otherwise “0” is obtained.

When “1” is obtained in expression (8) in this way, it is assumed that the condition for performing the walking (crossing) instruction (yₜ=2) is satisfied, and the crossing instruction (for example, the crossing instruction of the crosswalk, that is, the crossing notification) is performed to the visually impaired person in the stop state.

The state transition based on the above-mentioned logic may not be possible at a crosswalk at an intersection without a traffic light. In order to solve this issue, a new parameter t1>t0 may he introduced so that when it is determined that there is no state transition from the stop state during time t1, the state transitions to the walking state,

State Transition Function Applied in Crossing State

The state transition function f₂(j, Xₜ₊₁) used when the state amount at the previous time is the crossing state (sₜ=2) can be expressed by the following expression (11).

$$\begin{matrix}Expression 11 & \\ {f}_{2} ( J , {X}_{t + 1} ) = δ ( {\sum }_{t = t - t 0}^{t + 1} ( {b}^{t} + {r}^{t} + H ( {α}_{1} - {h}_{3}^{t} ) H ( {w}_{4}^{t} - {α}_{2} ) ) ) & ( 11 )\end{matrix}$$

In expression (11), “1” is obtained only when the traffic light and the crosswalk CW at the feet of the visually impaired person cannot be detected even once from the past t−t0 to the current time t+1, and otherwise “0” is obtained. That is, “1” is obtained only when the traffic light TL and the crosswalk CW at the feet of the visually impaired person cannot be detected because the visually impaired person has completed crossing the crosswalk CW.

When “1” is obtained in expression (11) in this way, it is assumed that the condition for performing the crossing completion is satisfied, and the notification of the crossing completion (completion of crossing the crosswalk) is performed to the visually impaired person in the walking state.

State Transition Function for Determining Deviation from Crosswalk

The state transition function f₃(j, Xₜ₊₁) for determining the deviation from the crosswalk CW while the visually impaired person crosses the crosswalk CW can be expressed by the following expressions (12) to (14).

$$\begin{matrix}Expression 12 & \\ {f}_{3} ( J , {X}_{t + 1} ) = H ( \frac{max ( {w}_{3}^{t + 1} , {w}_{5}^{t + 1} )}{{w}_{0}} - {α}_{3} ) & ( 12 )\end{matrix}$$

$$\begin{matrix}Expression 13 & \\ {w}_{3}^{t + 1} = {I}_{1}^{T} \{ ϕ ∘ g ( {X}_{t + 1} ) \} & ( 13 )\end{matrix}$$

$$\begin{matrix}Expression 14 & \\ {w}_{5}^{t + 1} = {I}_{3}^{T} \{ ϕ ∘ g ( {X}_{t + 1} ) \} & ( 14 )\end{matrix}$$

Here, α₃ is a parameter used for a determination criterion. Further, I₁={1,0,0,0,0,0}^{T} and I₃={0,0,1,0,0,0}^{T} hold.

In expression (12), “1” is obtained when the amount of deviation from the center of the frame at the position of the detected crosswalk CW is equal to or greater than an allowable amount, and otherwise “0” is obtained. That is, “1” is obtained when the value of w₃ becomes larger than the predetermined value (in the case of left deviation) or when the value of w₅ becomes larger than the predetermined value (in the case of right deviation).

When “1” is obtained in expression (12) in this way, the right deviation warning (yₜ=3) or the left deviation warning (yₜ=4) is performed.

Walking Support Operation

Next, the flow of the walking support operation performed by the walking support system 10 will be described.

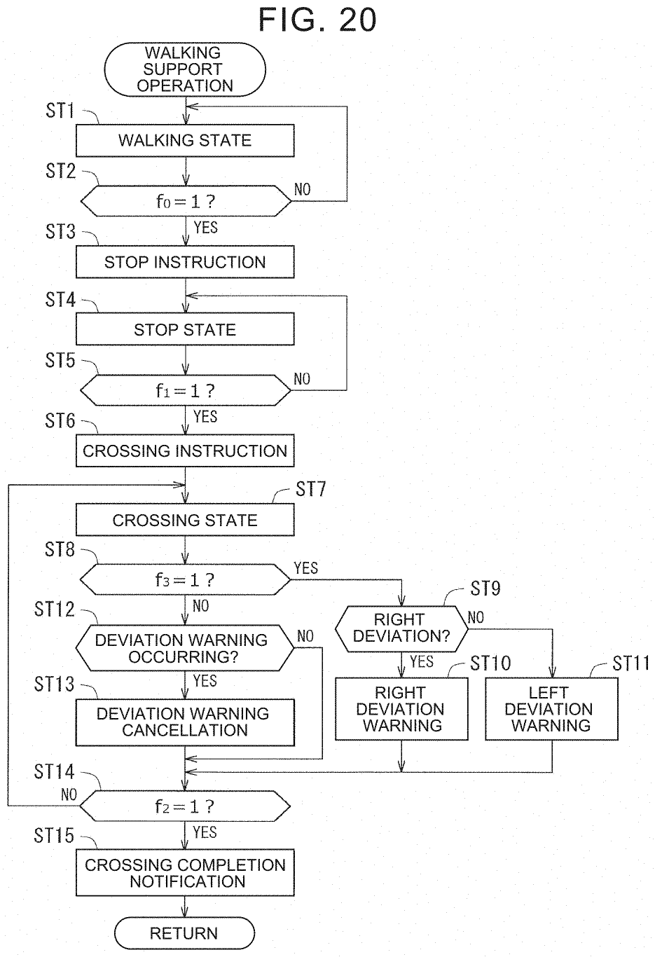

FIG. 20 is a flowchart showing a flow of a series of the walking support operation described above. This flowchart is repeatedly executed at a predetermined time interval so that one routine is executed from a predetermined time t to a predetermined time t+1 in a situation where a visually impaired person is walking on the street (on the sidewalk). In the following description, the description of the variable (J, Xₜ₊₁) in each state transition function will be omitted,

First, in the situation where the visually impaired person is in a walking state in step ST1, it is determined in step ST2 whether the existence of the crosswalk CW is detected (whether the existence of the crosswalk CW is detected by the crosswalk detection unit 82) from the image acquired by the camera 20. Specifically, it is determined whether “1” is obtained in the state transition function f₀ (the above expression (5)) for determining whether the condition for performing the above-mentioned stop instruction (yₜ=1) is satisfied based on the position of the white line WL1 of the crosswalk CW in the image area including the crosswalk CW recognized by the crosswalk detection unit 82 (more specifically, the position of the bounding box of the white line WL1 located in the frontmost position).

In step ST2, in determining whether the presence of the crosswalk CW is detected, each process (binarization process, white area combination process, bounding box setting process, bounding box comparison process, white area storage process, relative position comparison process, white line shape setting process) by the band shape setting unit 83 described above is performed. That is, in a situation where there is no area that cannot be confirmed as a white line based on the image acquired by the camera 20 and all the white lines in the crosswalk CW can be recognized, the existence of the crosswalk CW is detected from the image acquired by the camera 20. On the other hand, when there is an area that cannot be confirmed as a white line based on the image acquired by the camera 20, all the white lines WL1 to WL7 in the crosswalk CW are recognized by using the hounding box (extended and corrected bounding box) corresponding to the shape of the original white line set by each process (particularly, the white line shape setting process) by the band shape setting unit 83, thereby detecting the existence of the crosswalk CW.

When “0” is obtained in this state transition function f₀, NO is determined assuming that the condition for performing the stop instruction (yₜ=1) is not satisfied, that is, the visually impaired person has not yet reached a position before the crosswalk CW, and the process returns to step ST1. Since NO is determined in step ST2 until the visually impaired person reaches the position before the crosswalk CW, the operations of steps ST1 and ST2 are repeated.

When the visually impaired person reaches the position before the crosswalk CW and “1” is obtained in the state transition function f₀, YES is determined in step ST2, and the process proceeds to step ST3. In step ST3, the stop instruction (yₜ=1) is performed to the visually impaired person. Specifically, the vibration generation device 50 in the white cane 1 held by the visually impaired person vibrates in a pattern indicating the stop instruction (stop notification). As a result, the visually impaired person gripping the grip portion 3 of the white cane 1 recognizes that the stop instruction has been performed by sensing the vibration pattern of the vibration generation device 50, and stops walking.

In a situation where the visually impaired person is in the stop state in step ST4, it is determined in step ST5 whether “1” is obtained in the state transition function f₁ (the above expression (8)) for determining whether the condition for performing the above-mentioned walking instruction (yₜ=2) is satisfied. In the determination operation in this state transition function f₁, as shown in FIG. 12 described above, the area A surrounded by the dashed line is extracted, and for example, this area A is enlarged to facilitate determining the state of the traffic light TL.

When “0” is obtained in this state transition function f₁, NO is determined assuming that the condition for performing the walking instruction (yₜ=2) is not satisfied, that is, the traffic light TL has not yet switched to the green light, and the process returns to step ST4. Since NO is determined in step ST5 until the traffic light TL switches to the green light, the operations of steps ST4 and ST5 are repeated.

When the traffic light TL switches to the green light and “1” is obtained in the state transition function f₁, YES is determined in step ST5, and the process proceeds to step ST6. This operation corresponds to the operation of the switching recognition unit (switching recognition unit that recognizes that the state of the traffic light has switched from the stop instruction state to the crossing permission state) 85.

In step ST6, the walking (crossing) instruction (yₜ=2) is performed to the visually impaired person. Specifically, the vibration generation device 50 in the white cane 1 held by the visually impaired person vibrates in a pattern indicating the walking instruction (crossing start notification). As a result, the visually impaired person gripping the grip portion 3 of the white cane 1 recognizes that the walking instruction has been performed and starts crossing the crosswalk CW.

In a situation where the visually impaired person is crossing the crosswalk CW in the crossing state in step ST7, it is determined in step ST8 whether “1” is obtained in the state transition function f₃ (the above expression (12)) for determining whether the condition for warning the deviation from the crosswalk CW is satisfied.

When “1” is obtained in the state transition function f₃ and YES is determined in step ST8, it is determined in step ST9 whether the direction of the deviation from the crosswalk CW is the right direction (right deviation). When the direction of the deviation from the crosswalk CW is the right direction and YES is determined in step ST9, the process proceeds to step ST10, and the right deviation warning (yₜ=3) is performed to the visually impaired person. Specifically, the vibration generation device 50 in the white cane 1 held by the visually impaired person vibrates in a pattern indicating the right deviation warning. As a result, the visually impaired person gripping the grip portion 3 of the white cane 1 recognizes that the right deviation warning has been performed, and changes the walking direction toward the left direction.

On the other hand, when the direction of the deviation from the crosswalk CW is the left direction and NO is determined in step ST9, the process proceeds to step ST11, and the left deviation warning (yₜ=4) is performed to the visually impaired person. Specifically, the vibration generation device 50 in the white cane 1 held by the visually impaired person vibrates in a pattern indicating the left deviation warning. As a result, the visually impaired person gripping the grip portion 3 of the white cane 1 recognizes that the left deviation warning has been performed, and changes the walking direction toward the right direction. After performing the deviation warning in this way, the process proceeds to step ST14.

When there is no deviation from the crosswalk CW and “0” is obtained in the state transition function f₃, NO is determined in step ST8 and the process proceeds to step ST12. In step ST12, it is determined whether the deviation warning in step ST10 or step ST11 is currently occurring. When the deviation warning is not occurring and NO is determined in step ST12, the process proceeds to step ST14. On the other hand, when the deviation warning is occurring and YES is determined in step ST12, the process proceeds to step ST13 to cancel the deviation warning, and the process proceeds to step ST14.

In step ST14, it is determined whether “1” is obtained in the state transition function f₂ (the above expression (11)) for determining whether the condition for notifying the crossing completion is satisfied.

When “0” is obtained in this state transition function f₂, NO is determined assuming that the condition for notifying the crossing completion is not satisfied, that is, the visually impaired person is crossing the crosswalk CW, and the process returns to step ST7. Since NO is determined in step ST14 until the crossing of the crosswalk CW is completed, the operations of steps ST7 to ST14 are repeated.

That is, the following operation is performed until the crossing of the crosswalk CW is completed: when a deviation from the crosswalk CW occurs while the visually impaired person is crossing the crosswalk CW, the above-mentioned deviation warning is performed, and when this deviation is resolved, the deviation warning is canceled.

When the visually impaired person completes the crossing of the crosswalk CW and “1” is obtained in the state transition function f₂, YES is determined in step ST14, and the process proceeds to step ST15 to perform the notification of the crossing completion to the visually impaired person. Specifically, the vibration generation device 50 in the white cane 1 held by the visually impaired person vibrates in a pattern indicating the crossing completion. As a result, the visually impaired person gripping the grip portion 3 of the white cane 1 recognizes that the notification of the crossing completion has been performed, and returns to the normal walking state.

In this way, the above-described operation is repeated every time the visually impaired person crosses the crosswalk CW.

### Effect of Embodiment

As described above, in the present embodiment, when there is an area that cannot be confirmed as a white line based on the image captured by the camera 20 (the white line candidate bounding box described above), based on the relative position of an area that can be confirmed as a white line (the white line confirmed bounding box described above) with respect to an area that cannot be confirmed as a white line (based on whether the white line candidate bounding box is located in the area between the straight line L1 and the extension lines L1′, L1″ of the straight line L1, and the straight line L2 and the extension lines L2′, L2″ of the straight line L2), it is determined whether the area that cannot be confirmed as the white line is the area that can be regarded as the white line (the bounding box that can be regarded as the white line described above), and when it is determined that the area is the area that can be regarded as the white line, the shape of the area in the image is set to the shape as a white line (the shape as the bounding box surrounding the white line). As a result, even when a part of the white line is unclear and the white line cannot be confirmed as the white line only in the acquired image, a high recognition accuracy of the white line can be obtained and it is possible to appropriately support walking of the visually impaired person (perform the stop notification to the visually impaired person) according to the position of the white line.

Further, in the present embodiment, an image obtained by performing the binarization process on an image captured by the camera 20 and an image obtained by performing recognition of a white line by deep learning on the image captured by the camera 20 are compared with each other, and the area recognized as a candidate for a white line in both images is defined as an area that can be confirmed as a white line (white line confirmed bounding box), and the area recognized as a candidate for a white line in only one of the images of both images is defined as an area that cannot be confirmed as a white line (white line candidate bounding box). Therefore, it is possible to avoid erroneously extracting an area that is not a white line as an area that can be confirmed as a white line, which makes it possible to extract an area that can be confirmed as a white line and an area that cannot he confirmed as a white line with high accuracy.

Further, in the present embodiment, when an area that cannot be confirmed as a white line is located in the area between the straight line L1 connecting the edges of the one ends of the clear white lines (an area that can be confirmed as a white line) in the longitudinal direction of the white lines and the extension lines L1′, L1″ of the straight line L1, and the straight line L2 connecting the edges of the other ends and the extension lines L2′, L2″ of the straight line L2, this area is regarded as the white line. This makes it possible to improve the reliability of the determination that the area that cannot be confirmed as a white line is regarded as the area that can be regarded as a white line.

Further, in the present embodiment, since the walking support system 10 is realized only with the white cane 1 by incorporating the components of the walking support system 10 into the white cane 1, a highly practical walking support system 10 can be provided.

When Targeting Crosswalk in Which Part of White Lines Has Different Dimension in Longitudinal Direction

The walking support system 10 according to the above-described embodiment can obtain high recognition accuracy of the white lines by the same processes even when targeting a crosswalk in which a part of the white lines has a different dimension in the longitudinal direction, Hereinafter, a specific description will be given.

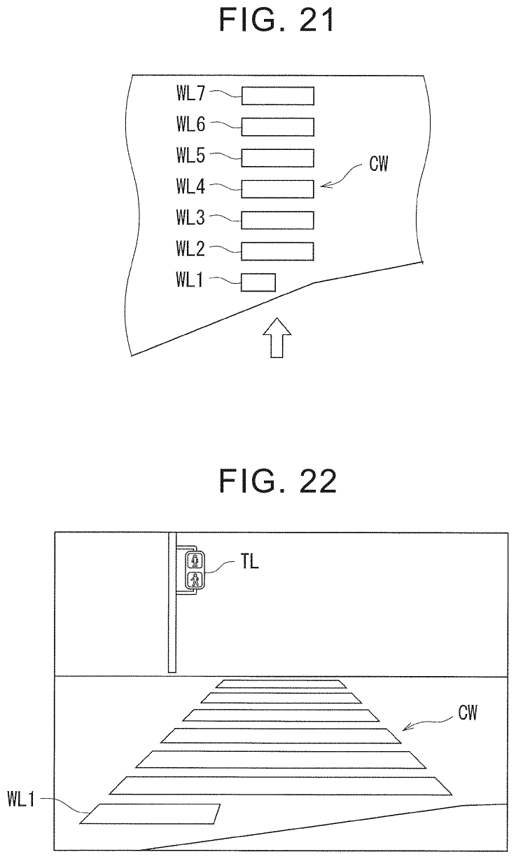

FIG. 21 is a plan view around a crosswalk CW in which a part of the white lines has a different dimension in the longitudinal direction. The arrow in FIG. 21 indicates the traveling direction of the visually impaired person with respect to the crosswalk CW (direction approaching the crosswalk CW). FIG. 22 is a diagram showing an example of an image, captured by the camera 20, of a crosswalk CW in which the length dimension of the white line WL1 closest to a pedestrian on the crosswalk CW is shorter than the length dimensions of other white lines. When such an image is acquired, the white line WL1 closest to the pedestrian cannot be confirmed as a white line, and it is difficult to accurately recognize the white line. In such a situation, it is conceivable to set the threshold value in the length direction of the white line (for example, α₂ in the above-mentioned expression (5)), which is one of the conditions for recognizing the white line, to a small value to be able to confirm that even a white line having a short dimension in the longitudinal direction is a white line. However, in this case, a white object that is not a white line may be erroneously recognized as a white line, so it cannot be said to be an effective method.

In the present embodiment, even in such a situation, each process (binarization process, white area combination process, bounding box setting process, bounding box comparison process, white area storage process, relative position comparison process, white line shape setting process) by the band shape setting unit 83 described above is performed in order so that high recognition accuracy of white lines can be obtained.

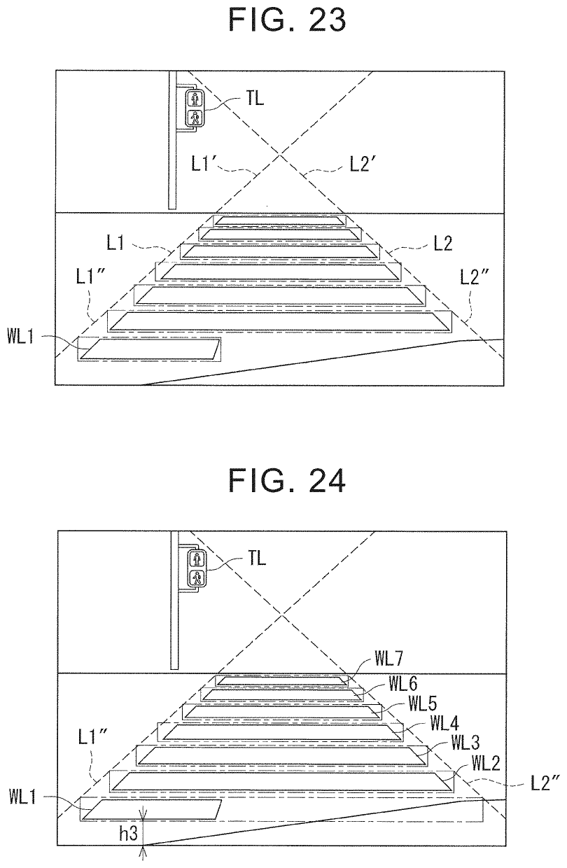

FIG. 23 is a diagram illustrating the relative position comparison process in this case. As shown in FIG. 23, in the relative position comparison process, it is determined whether the white line candidate hounding box is located in an area between the straight line L1 and the extension lines L1′, L1″ of the straight line L1, and the straight line L2 and the extension lines L2′, L2″ of the straight line L2. The straight line L1 connects edges of one ends in the longitudinal direction (right-left direction in FIG. 23) of each white line confirmed bounding box and the straight line L2 connects edges of the other ends thereof. In FIG. 23, among the plurality of white line candidate bounding boxes, the bounding box set for the lit area in the pedestrian traffic light TL does not exist in the area between the straight lines L1, L1′, L1″, L2, L2′, L2″ (specifically, between the straight lines L1′ and L2′). Therefore, this white line candidate hounding box is determined to be a bounding box that is not regarded as a white line. On the other hand, among the plurality of white line candidate bounding boxes, the bounding box for the white line WL1 having a short length dimension exists in the area between the straight lines L1, L1′, L1″, L2, L2′, L2″ (specifically, between the straight lines L1″ and L2″). Therefore, this white line candidate bounding box is determined to be a bounding box that is regarded as a white line.

With the above operation, the areas that can be confirmed as a white line in the image (bounding box corresponding to the white line) are the bounding boxes set for the white lines WL2 to WL7 described above and the white line candidate bounding box existing in the area between the straight lines L1, L1′, L1″, L2, L2′, L2″ (the bounding box for the white line WL1 having a short length dimension).

FIG. 24 is a diagram illustrating a white line confirmed hounding box complemented in the white line shape setting process when targeting a crosswalk in which a part of the white lines has a different dimension in the longitudinal direction. As shown in FIG. 24, in the white line shape setting process, the length dimension of the bounding box (the dimension in the right-left direction in the figure) that is regarded as the white line in the relative position comparison process (the bounding box for the white line WL1 having a short length dimension) is extended to the position corresponding to each of the straight lines L1″ and L2″ in the length direction of the bounding box.

In this way, even when targeting a crosswalk in which a part of the white lines has a different dimension in the longitudinal direction, it is determined whether the area that cannot be confirmed as a white line is an area that can be regarded as a white line, and when it is determined that the area is an area that can be regarded as a white line, the shape of the area in the image is set to the shape as a white line. Therefore, it is possible to obtain high recognition accuracy of the white line, and it is possible to appropriately support walking of the visually impaired person (perform the stop notification to the visually impaired person) according to the position of the white line.

Modification

Next, a modification will be described. In the present modification, in addition to the configuration and function of the walking support system 10 according to the above-described embodiment, processing is performed according to the area ratio of the area where the white line is unclear. Therefore, only the part added to the above-described embodiment will be described here.

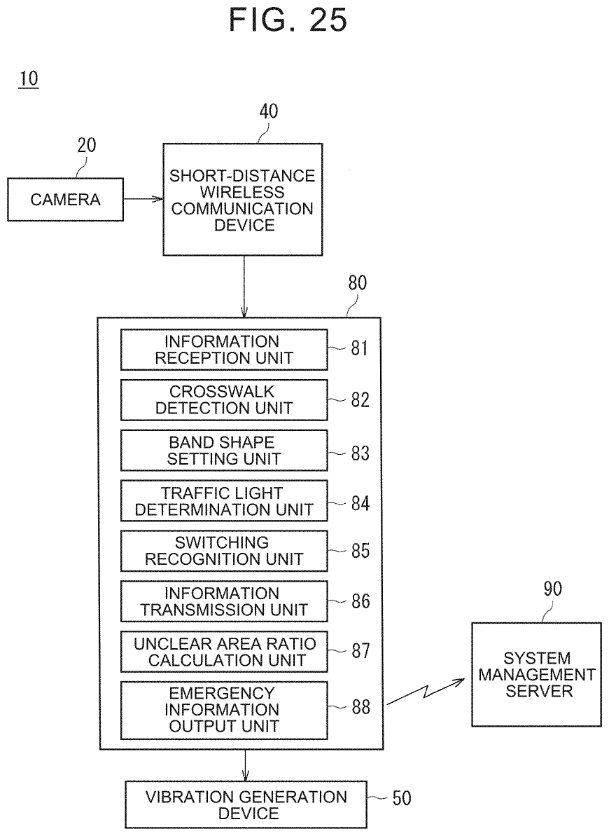

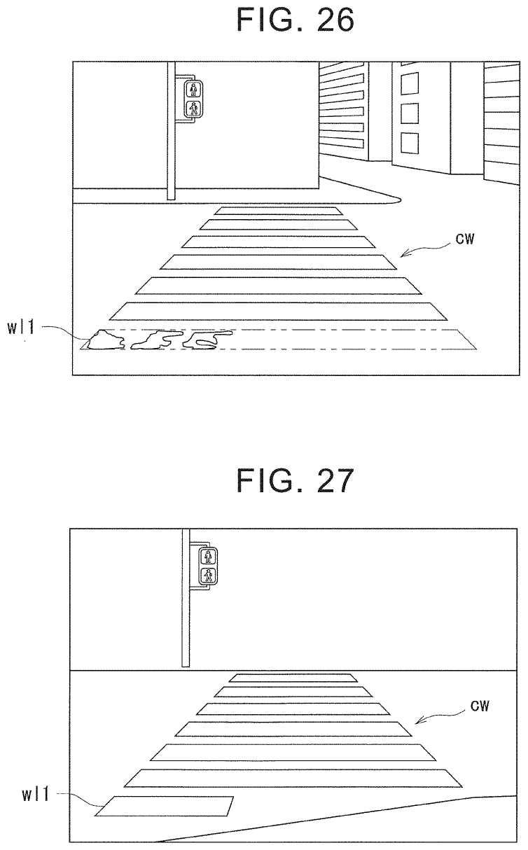

FIG. 25 is a block diagram showing a schematic configuration of a control system of the walking support system 10 according to the present modification. As shown in FIG. 25, in the control system of the walking support system 10 according to the present modification, as functional units realized by the control program, an unclear area ratio calculation unit 87 and an emergency information output unit 88 are provided in addition to the above-described embodiment.

When there is an area that cannot be confirmed as a white line due to the occurrence of blurring (blurring due to peeling off of paint) in a part of the white line, the unclear area ratio calculation unit 87 calculates the ratio of the area of the area where the paint is peeled off with respect to the area of the entire area of the shape as the white line set by the band shape setting unit 83. As a method of calculating the ratio of this area, a method of dividing each area into a plurality of pixels and calculating the ratio of the number of pixels in each area can be exemplified.

When the calculated ratio (ratio of the area of the area where the paint is peeled off) is equal to or more than a predetermined value, the unclear area ratio calculation unit 87 transmits the information to the emergency information output unit 88.

The emergency information output unit 88 outputs emergency information when the information (information indicating that the ratio of the area of the area where the paint is peeled off is equal to or more than the predetermined value) is received from the unclear area ratio calculation unit 87. This emergency information is output to the information transmission unit 86, and is also output to a system management server 90 that collectively manages the plurality of walking support systems 10.

When the information transmission unit 86 receives the emergency information from the emergency information output unit 88, the information transmission unit 86 outputs information for notifying the visually impaired person of prohibition of crossing the crosswalk to the vibration generation device 50. As a result, the information transmission unit 86 outputs a signal to the vibration generation device 50 for notifying prohibition of the crossing of the crosswalk, and the vibration generation device 50 vibrates in a pattern indicating the prohibition of the crossing. Accordingly, the visually impaired person stops crossing the crosswalk. That is, even if it is determined that the area that cannot be confirmed as a white line is an area that can be regarded as a white line, when the ratio of the unclear area is equal to or more than the predetermined value, the reliability of the determination is unlikely to be sufficiently high. Therefore, when the ratio of the unclear area is equal to or more than the predetermined value, the visually impaired person is notified of prohibition of the crossing of the crosswalk, so that appropriate walking support can be provided to the visually impaired person.

Further, when the system management server 90 receives the emergency information from the emergency information output unit 88, the system management server 90 accumulates the emergency information (the information indicating that a white line in which the ratio of the area of the area where the paint is peeled off is equal to or more than the predetermined value exists). The system management server 90 can communicate with a large number of walking support systems 10, and when the emergency information is received from the emergency information output unit 88 provided in each walking support system 10, the system management server 90 accumulates the emergency information. This makes it possible to accumulate the information as big data to be supplied to each walking support system 10. In addition, the information can be effectively used as information indicating that the white lines require repair. For example, it is possible to provide information to an organization (for example, a municipality) or a repair company that manages and repairs the white lines,

### Other Embodiments

It should be noted that the present disclosure is not limited to the above-described embodiment or the above-described modification, and all modifications and applications included in the claims and the range equivalent to the claims can be applied.

For example, in the above-described embodiment and the above-described modification, a case where the walking support system 10 is built in the white cane 1 used by a visually impaired person has been described. The present disclosure is not limited to this, and the walking support system 10 may be built in a cane, a wheel walker, or the like when the pedestrian is an elderly person.

Further, in the above-described embodiment and the above-described modification, the white cane 1 is provided with the charging socket 70 and the battery (secondary battery) 60 is charged from a household power source. The present disclosure is not limited to this, and a photovoltaic power generation sheet may be attached to the surface of the white cane 1 to charge the battery 60 with the electric power generated by the photovoltaic power generation sheet. Further, a primary battery may be used instead of the secondary battery. Furthermore, the white cane 1 may have a built-in pendulum generator, and the pendulum generator may be used to charge the battery 60.

In the above-described embodiment and the above-described modification, the types of notifications are classified according to the vibration pattern of the vibration generation device 50. The present disclosure is not limited to this, and the notifications may be performed by voice.

The present disclosure is applicable to a walking support system that supports walking of a visually impaired person who walks.

What is claimed is:

1. A walking support system that supports walking for a pedestrian in a situation where the pedestrian approaches a crosswalk, the walking support system comprising:
an image acquisition unit that acquires an image in front of the pedestrian who is walking;
a crosswalk detection unit that is able to detect the crosswalk based on the image acquired by the image acquisition unit; and
a band shape setting unit that is able to extract an area that is able to be confirmed as a band constituting the crosswalk and an area that is not able to be confirmed as the band based on the image acquired by the image acquisition unit, that determines whether the area that is not able to be confirmed as the band is an area that is able to be regarded as the band based on a relative position of the area that is not able to be confirmed as the band with respect to the area that is able to be confirmed as the band when there is the area that is not able to be confirmed as the band, and that sets a shape of the area that is not able to be confirmed as the band in the image to a shape as the band when determining that the area that is not able to be confirmed as the band is the area that is able to be regarded as the band.

2. The walking support system according to claim 1, wherein:
the crosswalk detection unit acquires information on a band shape set by the band shape setting unit when there is the area that is not able to be confirmed as the band, and recognizes an edge position of the crosswalk closer to the pedestrian based on the information; and
the walking support system includes a notification unit that performs a stop notification for urging the pedestrian to stop when the pedestrian reaches a position before the recognized edge position closer to the pedestrian.

3. The walking support system according to claim 1, wherein the band shape setting unit is configured to compare an image obtained by performing a binarization process on the image acquired by the image acquisition unit and an image obtained by performing recognition of a band by deep learning on the image acquired by the image acquisition unit, and define an area recognized as a band confirmed area in both images as the area that is able to be confirmed as the band and define an area recognized as the band confirmed area in only one image of the both images as the area that is not able to he confirmed as the band.

4. The walking support system according to claim 1, wherein when there is a plurality of areas that is able to he confirmed as the band, the band shape setting unit is configured to determine that the area that is not able to be confirmed as the band is the area that is able to be regarded as the band, on condition that the area that is not able to be confirmed as the band is located in an area between a first straight line connecting edges of one ends of the areas in a longitudinal direction of the band and extension lines of the first straight line, and a second straight line connecting edges of the other ends and extension lines of the second straight line.

5. The walking support system according to claim 1, further comprising:
an unclear area ratio calculation unit that calculates a ratio of an area of an area where paint is peeled off with respect to an area of an entire area of a shape as the hand set by the hand shape setting unit, when the area that is not able to be confirmed as the hand is unclear due to peeling off of a part of the paint constituting the band; and
an emergency information output unit that outputs emergency information when the ratio of the area of the area where the paint is peeled off that is calculated. by the unclear area ratio calculation unit is equal to or more than a predetermined value.

6. The walking support system according to claim 5, wherein the emergency information output unit is configured to output the emergency information to a system management server that collectively manages the walking support system.

7. The walking support system according to claim 5, wherein the emergency information output unit is configured to output the emergency information as information for notifying the pedestrian of prohibition of crossing the crosswalk.

8. The walking support system according to claim 1, wherein each of the image acquisition unit, the crosswalk detection unit, and the band shape setting unit is built in a white cane used by a visually impaired person as the pedestrian.

9. The walking support system according to claim 2, wherein the notification unit is built in a white cane used by a visually impaired person as the pedestrian, and is configured to perform notification to the visually impaired person using the white cane by vibration or voice.
